(19) United States
(12) Patent Application Publication
(10) Pub. No.: US 2024/0208070 A1
(43) Pub. Date: Jun. 27, 2024

(54) INTELLIGENT ROBOT

(71) Applicant: KOREA INSTITUTE OF SCIENCE AND TECHNOLOGY, Seoul (KR)

(72) Inventor: Sehyuk YIM, Seoul (KR)

(73) Assignee: KOREA INSTITUTE OF SCIENCE AND TECHNOLOGY, Seoul (KR)

(21) Appl. No.: 18/303,650

(22) Filed: Apr. 20, 2023

(30) Foreign Application Priority Data
Dec. 26, 2022 (KR) 10-2022-0184299

(51) Int. Cl. B25J 11/00; B25J 9/16; B25J 13/00

(52) U.S. Cl. CPC B25J 11/0015; B25J 9/161; B25J 13/003; B25J 19/00

(57) ABSTRACT

An intelligent robot according to an embodiment is disclosed. The intelligent robot according to an embodiment includes at least one processor and a memory configured to store instructions for executing the at least one processor, wherein the intelligent robot includes a plurality of members stacked with gaps to form a shape of a face, and at least one flexible structure disposed in at least one of the gaps, and wherein when the instructions are executed by the at least one processor, the instructions cause the at least one processor to control a motion of the face by applying a force to a power transmission element connected to at least one of the plurality of members based on an audio input.

### DESCRIPTION OF GOVERNMENT-FUNDED RESEARCH AND DEVELOPMENT

This research is conducted under the support of scientific culture exhibition service capability enhancement support business, [Project Name: Soft kinetic display technology and content research for creative-educational-participative scientific culture exhibition, Project Serial Number: 1711156930, Project ID Number: 2020X1A3A1096943], Ministry of Science and ICT.

### CROSS-REFERENCE TO RELATED APPLICATION

This application claims priority to Korean Patent Application No. 10-2022-0184299, filed on Dec. 26, 2022, and all the benefits accruing therefrom under 35 U.S.C. § 119, the contents of which in its entirety are herein incorporated by reference.

### BACKGROUND

### 1. Field

The present disclosure relates to an intelligent robot, and more particularly, to an intelligent robot whose motion is controlled based on audio input.

### 2. Description of the Related Art

With the development of computer technology, intelligent robots capable of interacting with users are being used. The intelligent robots interact with users by controlling expression or motion in response to audio input. The intelligent robots make lifelike movement by mimicking the human's expression or motion.

In relation to this, animatronics based intelligent robots are built for interactions with users. However, in general, the animatronics based intelligent robots are manufactured with costly components due to sophisticated mechanisms. Additionally, the animatronics based intelligent robots require a plurality of devices for operation, and the uncanny valley phenomenon occurs due to unnatural movement.

The intelligent robots capable of interacting human need to be reasonable in terms of cost and implementation to allow easier access. Furthermore, the intelligent robots need to make more human-like responses for immersive interactions.

### SUMMARY

An intelligent robot according to an embodiment includes at least one processor and a memory configured to store instructions for executing the at least one processor, wherein the intelligent robot includes a plurality of members stacked with gaps to form a shape of a face, and at least one flexible structure disposed in at least one of the gaps, and wherein when the instructions are executed by the at least one processor, the instructions cause the at least one processor to control a motion of the face by applying a force to a power transmission element connected to at least one of the plurality of members based on an audio input.

The plurality of members may have a plate-shaped structure, at least some of the members may be connected by the flexible structure, and the gaps may be present between the plurality of members.

The face may be formed in a hollow 3-dimensional shape to form an accommodation space.

When the instructions are executed by the at least one processor, the instructions may cause the at least one processor to turn on or off light in an upward or downward direction by a light source on top or bottom of the intelligent robot inside of the intelligent robot.

Each of the plurality of members may have at least one groove on an outer periphery thereof.

The power transmission element may be inserted into each of the at least one groove, the power transmission element having an end connected to at least one of the plurality of members and an opposite end connected to a motor installed inside or outside of the intelligent robot.

The face of the intelligent robot may be formed by stacking the plurality of members in a shape of a human's face including at least one of eyes, a nose or a mouth.

When the instructions are executed by the at least one processor, the instructions may cause the at least one processor to control the motion of the face by controlling a motor to apply a tension force to the power transmission element having an end connected to at least one of the plurality of members and an opposite end connected to the motor.

When the instructions are executed by the at least one processor, the instructions may cause the at least one processor to control the motion of the face by controlling at least one of torque or a number of revolutions of the motor to widen or narrow the gaps between the plurality of members.

When the instructions are executed by the at least one processor, in case that a peak of the audio input is equal to or more than a preset size, the instructions may cause the at least one processor to scale up the motion of the face corresponding to the peak.

When the instructions are executed by the at least one processor, the instructions may cause the at least one processor to control the face by a first motion for a first segment before a first syllable identified by splitting the audio input into syllables, and control the face by a second motion for a second segment after a last syllable of the audio input.

The first motion may be a first oral motion set based on a human's mouth shape formed to output the first syllable, and the second motion may be a second oral motion set based on the human's mouth shape formed to silence after the last syllable.

The light source may be installed in the accommodation space, so that a light emitted from the light source leaks through the gaps between the plurality of members, causing the intelligent robot to glow.

The light source may be installed in the accommodation space and at least one of the plurality of members and flexible structure may be produced by a semitransparent material, so that the light emitted from the light source is scattered from inside the intelligent robot to the outside, causing the intelligent robot to glow.

The light source is installed in the accommodation space and at least one of the plurality of members and the flexible structure is produced by an opaque material, so that the light emitted from the light source is scattered in at least one of the plurality of members and flexible structure forming the intelligent robot.

The intelligent robot according to an embodiment may provide the sense of immersion to interactions with users by controlling the motion based on the audio input.

The intelligent robot according to an embodiment may improve the synchronization level with the audio input without limitations of the used language by controlling the motion based on the size of the audio input.

The intelligent robot according to an embodiment may provide facial motion that can overcome the uncanny valley beyond similarity to human articulatory motion by adjusting the control timing between the audio input and the motion.

The intelligent robot according to an embodiment may make the motion look bigger through light traveling between the stack structures.

The intelligent robot according to an embodiment may provide smooth motion through the flexible structure.

### BRIEF DESCRIPTION OF THE DRAWINGS

FIG. 1 is a diagram illustrating an intelligent robot according to an embodiment.

FIG. 2 is a diagram illustrating an external structure of an intelligent robot according to an embodiment.

FIG. 3 is a diagram illustrating an internal structure of an intelligent robot according to an embodiment.

FIG. 4 is a diagram illustrating a working mechanism of an intelligent robot according to an embodiment.

FIG. 5 is a diagram illustrating a working mechanism of an intelligent robot according to an embodiment.

### DETAILED DESCRIPTION

The terms as used herein are general terms selected as those being now used as widely as possible in consideration of functions, but they may vary depending on the intention of those skilled in the art or the convention or the emergence of new technology. Additionally, in certain cases, there may be terms arbitrarily selected by the applicant, and in this case, the meaning will be described in the corresponding description part of the specification. Accordingly, it should be noted that the terms as used herein should be interpreted based on the substantial meaning of the terms and the context throughout the specification, rather than simply the name of the terms.

Additionally, the embodiments described herein may have aspects of entirely hardware, partly hardware and partly software, or entirely software. The term “unit”, “module”, “device”, “server” or “system” used herein refers to a computer related entity such as hardware, a combination of hardware and software, or software. For example, the unit, module, device, server or system may refer to hardware that constitutes a platform in whole or in part and/or and software such as an application for running the hardware.

Hereinafter, the embodiments will be described is in detail with reference to the accompanying drawings and the disclosure in the accompanying drawings, but the scope of protection is not limited or restricted by the embodiments.

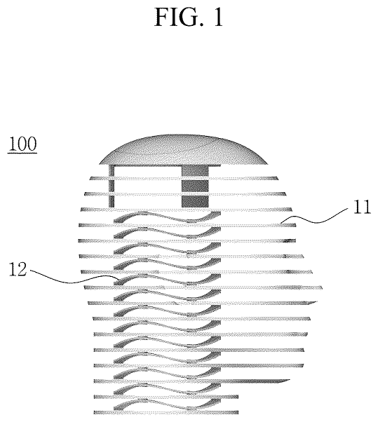

FIG. 1 is a diagram illustrating an intelligent robot 100 according to an embodiment.

Referring to FIG. 1, the intelligent robot 100 according to an embodiment includes a plurality of members 11, a flexible structure 12 and a control unit (not shown).

Here, the control unit (not shown) may be implemented or realized by at least one processor included in the intelligent robot 100, and the control unit (not shown) may be replaced with the at least one processor.

The plurality of members 11 is stacked with gaps to form a shape of a face. The plurality of members 11 may be the members 11 formed by slicing a 3-dimensional (3D) target object. The plurality of members 11 may be the members 11 formed by slicing the 3D target object in the horizontal direction.

The flexible structure 12 is disposed in the gaps between the plurality of members 11. The flexible structure 12 may be disposed in at least one of the gaps between the plurality of members 11. For example, the flexible structure 12 may be disposed in each of the plurality of gaps or only some gaps.

The flexible structure 12 may include a structure made of at least one of silicone, rubber, glass fibers and iron. The flexible structure 12 may be made of a transparent material on at least one surface to allow light to pass therethrough or may be made up of skeletons with gaps.

The flexible structure 12 may include a structure made of at least one of The flexible structure 12 may be an elastic structure that becomes longer or changes shape when forces are applied, and returns to the original length and shape when the applied forces are removed. The flexible structure 12 may be a structure that is resistant to external forces without breakage or deformation by the applied forces.

For example, the flexible structure 12 may include a spring structure. In a specific example, the flexible structure 12 may include a disc spring that curves with the same curvature.

The flexible structure 12 may be connected to at least one of the plurality of members 11 to connect the plurality of members 11. The flexible structure 12 may be attached to at least one of the plurality of members 11 to connect the plurality of members 11. The flexible structure 12 may be adhered to at least one of the plurality of members 11 to connect the plurality of members 11.

The control unit (not shown) may control the motion of the face by controlling a motor 50 to apply a tension force to a power transmission element having one end connected to at least one of the plurality of members 11 and the other end connected to the motor 50. In this instance, the power transmission element is used to transmit the tension force generated from the motor 50, and may include, for example, a thread, a string or a cord.

The control unit (not shown) may control the motion of the face by controlling at least one of the torque or the number of revolutions of the motor 50 to increase or decrease the distance between the plurality of members 11.

When the audio input includes a preset keyword, the control unit (not shown) may control the motion of the face based on a set scenario corresponding to the preset keyword. Here, the set scenario may be the motion of the face for which at least one of the torque or the number of revolutions of the motor 50 is differently set by the control unit.

Here, the audio input may be audio data outputted from the inside or outside of the intelligent robot.

For example, the audio input may include the sound of a song containing lyrics outputted through a speaker attached to the inside of the intelligent robot. The audio input may include audio data of a rhythmic voice extracted from the sound of the song outputted through the speaker.

In another example, the audio input may be audio data that outputs the content of a message outputted based on Text To Speech (TTS) conversion. In a specific example, the audio input may include an audio commentary using TTS outputted through the speaker attached to the inside of the intelligent robot.

When the peak of the audio input is equal to or more than a preset first size, the control unit (not shown) may scale up the motion of the face corresponding to the peak of the audio input. The control unit (not shown) may split the audio input by a preset time unit, and when the peak of the audio size is equal to or more than the preset first size in the split segments, may scale up the motion of the face corresponding to the segment including the peak that is equal to or more than the preset first size. The control unit (not shown) may scale up the motion of the face corresponding to the segment including the peak that is equal to or more than the preset first size in proportion to an absolute value of a difference from the preset first size or a ratio value to the preset first size.

When the peak of the audio input is equal to or less than a preset second size, the control unit (not shown) may scale down the motion of the face corresponding to the peak of the audio input. The control unit (not shown) may split the audio input by a preset time unit, and when the peak of the audio size is equal to or less than the preset second size in the split segments, may scale down the motion of the face corresponding to the segment including the peak that is equal or less than the preset second size. The control unit (not shown) may scale down the motion of the face corresponding to the segment including the peak that is equal to or less than the preset second size in proportion to an absolute value of a difference from the preset second size or a ratio value to the preset second size.

The control unit (not shown) may control the face by a first motion for the first segment before the first syllable identified by splitting the audio input into syllables. The control unit (not shown) may control the face by a second motion for the second segment after the last syllable identified by splitting the audio input into syllables.

Here, the first motion may be a first oral motion set based on the human's mouth shape formed to output the first syllable. The second motion may be a second oral motion set based on the human's mouth shape formed to silence after the last syllable.

In a specific example, when the audio input to the control unit (not shown) is “I am happy” extracted from a song, the control unit (not shown) may split the audio input “I am happy” made up of each syllable “I”, “am”, “hap”, “py” into the plurality of segments.

Here, the control unit (not shown) may control the motion of the face by the mouth shape formed by the human to output “I” for the first segment before the first syllable “I.”

The control unit (not shown) may control the motion of the face by the mouth shape formed to silence after outputting “py” for the second segment after the last syllable “py.”

Here, the mouth of the intelligent robot 100 controlled in the plurality of members 11 may change in shape.

Although the present disclosure describes that the control unit (not shown) splits the audio input into syllables, this is provided by way of illustration, and the control unit (not shown) may split the audio input by a preset time or a preset number of frames, but is not necessarily limited thereto.

The control unit (not shown) may control the face by adding the predetermined segment to each of the start and end of each syllable identified by splitting the audio input into syllables.

Specifically, the control unit (not shown) may control the motion of the face by a first spacing motion corresponding to a first spacing with the addition of the first spacing before the start of each syllable identified by splitting the audio input into syllables.

The control unit (not shown) may control the motion of the face by a second spacing motion corresponding to a second spacing with the addition of the second spacing to the end of each syllable identified by splitting the audio input into syllables.

Here, the first spacing motion may be a motion set based on the human's mouth shape formed to output the syllable corresponding to the first spacing. The second spacing motion may be a motion set based on the human's mouth shape formed to terminate the syllable corresponding to the second spacing.

In a specific example, when the audio input to the control unit (not shown) is “I love you” extracted from a song, the control unit (not shown) may split the audio input “I love you” made up of each syllable “I”, “love”, “you” into the plurality of segments.

Here, the control unit (not shown) may control the face based on the human's mouth shape formed to output the syllable “I” corresponding to the first spacing with the addition of the first spacing before the start of the first syllable “I.”

The control unit (not shown) may control the face based on the human's mouth shape formed to terminal the syllable “I” corresponding to the second spacing with the addition of the second spacing at the end of the first syllable “I.”

Here, the audio input may be sampled by extracting a curve connecting points at which the amplitude is at maximum in the sound waves of the original audio to make it to be clearly. Here, the sampling frequency may be 20 Hz to 25 Hz.

In this instance, for example, when 1-Sigma away from the mean is set as a maximum value, the maximum value of the sampled audio may be fixed. Here, the fixed sampled audio may be de-noised by applying a filter.

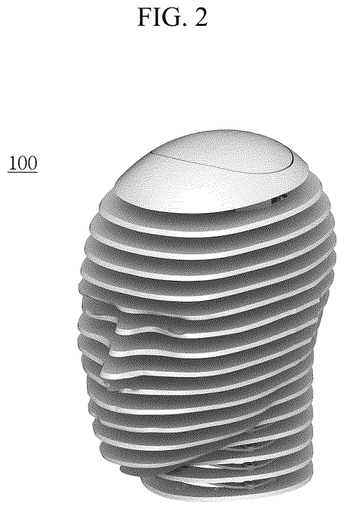

FIG. 2 is a diagram illustrating the external structure of the intelligent robot 100 according to an embodiment.

Referring to FIG. 2, the intelligent robot 100 according to an embodiment may be formed in a human shape in 3D.

The intelligent robot 100 according to an embodiment may be formed by stacking the plurality of members 11 in the shape of the head including the human face. For example, the intelligent robot 100 may be formed by stacking the plurality of members 11 in the shape of the human face including at least one organ of eyes, nose, mouth or neck.

The plurality of members 11 may be stacked by the preset distance apart from each other to have the gaps to allow light emitted from an internal lighting unit 30 as described below to pass therethrough.

Although the present disclosure describes the 3D object intended to form the shape of the intelligent robot 100 as a human, this is provided by way of illustration, and the 3D object is not limited to a particular type, and in addition to the human, the 3D object may include animals, plants, characters or the like.

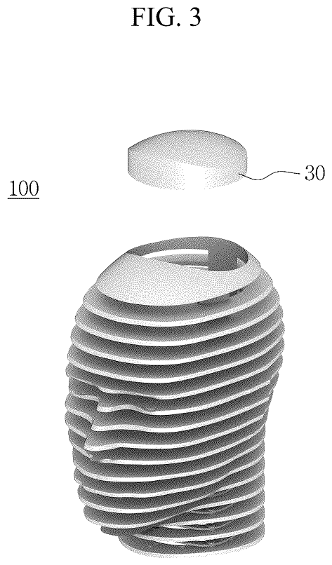

FIG. 3 is a diagram illustrating the internal structure of the intelligent robot 100 according to an embodiment.

Referring to FIG. 3, the intelligent robot 100 according to an embodiment may be formed in a hollow 3D shape to form an accommodation space inside.

In this instance, the intelligent robot 100 according to an embodiment may include the lighting unit 30 from the accommodation space.

Here, the lighting unit 30 may be executed or implemented by the at least one processor included in the intelligent robot 100, and the lighting unit 30 may be replaced with the at least one processor.

The lighting unit 30 may be disposed on top or bottom of the intelligent robot 100 inside of the intelligent robot 100 to emit light from a light source in the upward or downward direction, respectively. Alternatively, the lighting unit 30 may be included in the empty accommodation space within the intelligent robot 100 to emit light.

Specifically, the light source may be installed in the accommodation space formed by emptying the inside of the intelligent robot 100. The light emitted from the light source may leak through the gaps between the plurality of members 11, and cause the intelligent robot 100 to glow.

In this instance, at least one of the plurality of members 11 and flexible structure 12 may be produced by the semitransparent material, so that the light emitted from the light source may be scattered from inside the intelligent robot 100 to the outside, cause the intelligent robot 100 to glow.

Alternatively, the light source may be installed in the accommodation space and at least one of the plurality of members 11 and the flexible structure 12 may be made of an opaque material, so that the light emitted from the light source is scattered in at least one of the plurality of members 11 and flexible structure 12 forming the intelligent robot 100.

Specifically, the opaque material may be designed to partially or completely block light or other electromagnetic waves. The opaque materials may scatter within itself and partially transmit the light. In this instance, the opaque materials may be produced by a powder-based 3D printing technology.

The lighting unit 30 may be connected to the control unit (not shown) to communicate with the control unit, and may be controlled to respond to the audio input based on a signal received from the control unit.

The intelligent robot 100 may have a larger amount of transmitted light when the gaps between the plurality of members 11 are wider and a smaller amount of light transmitted from the lighting unit 30 when the gaps between the plurality of members 11 are narrower in the following manner. Accordingly, the intelligent robot 100 may provide the sense of immersion to the facial motion with varying sizes of the gaps between the plurality of members 11 that match the audio input and varying amounts of emitted light depending on the size of the gap.

Although FIG. 3 shows the lighting unit 30 on top of the intelligent robot 100 inside of the intelligent robot 100, this is provided by way of illustration but not necessarily limited thereto.

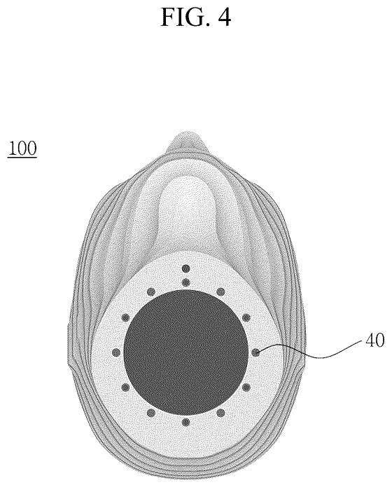

FIG. 4 is a diagram illustrating the working mechanism of the intelligent robot 100 according to an embodiment.

Referring to FIG. 4, the plurality of members 11 of the intelligent robot 100 according to an embodiment includes at least one groove 40.

Here, the at least one groove 40 may be formed on the outer periphery of each of the plurality of members 11. The plurality of members 11 of the intelligent robot 100 according to an embodiment may include the at least one groove 40 for facial motion.

Specifically, each of the plurality of members 11 may have the plurality of grooves 40 uniformly arranged on the outer periphery thereof. Each of the plurality of members 11 may have the plurality of grooves 40 on the outer periphery thereof at a uniform angle from the origin. For example, when each of the plurality of members 11 includes 12 grooves 40, the 12 grooves 40 may be disposed at an angle of 30° between them with respect to the center as shown in FIG. 4.

The power transmission element may be inserted into the at least one groove 40.

Here, the power transmission element may be an element attached to at least one of the plurality of members 11 to transmit a downward tension force to the plurality of members 11.

For example, the first power transmission element may be attached to the first member 11 disposed at the topmost location from the bottom among the plurality of members 11 to move all the plurality of members 11. In this instance, the power transmission element attached to the first member 11 may transmit the tension force of the whole face. That is, the first power transmission element may be attached to the first member 11 among the plurality of members 11 to allow all the plurality of members 11 and the flexible structure 12 included in the intelligent robot 100 to receive the downward tension force.

The second power transmission element may be attached to the second member 11 disposed at a location corresponding to the left eye of the face. The third power transmission element may be attached to the third member 11 disposed at a location corresponding to the right eye of the face. The fourth power transmission element may be attached to the fourth member 11 disposed at a location corresponding to the nose of the face. The fifth power transmission element may be attached to the fifth member 11 disposed at a location corresponding to the mouth of the face. The sixth power transmission element may be attached to the sixth member 11 disposed at a location corresponding to the neck of the face.

The power transmission element may be inserted into the grooves 40 present in the plurality of members 11 and attached to the member 11 corresponding to the part of the face to be controlled in order to transmit the power.

Specifically, the first power transmission element may be inserted into the at least one groove 40 present in the plurality of members 11 and attached to the first member 11. The second power transmission element may be inserted into the at least one groove 40 present in the plurality of members 11 and attached to the second member 11. The third power transmission element may be inserted into the at least one groove 40 present in the plurality of members 11 and attached to the third member 11. The fourth power transmission element may be inserted into the at least one groove 40 present in the plurality of members 11 and attached to the fourth member 11. The fifth power transmission element may be inserted into the at least one groove 40 present in the plurality of members 11 and attached to the fifth member 11. The sixth power transmission element may be inserted into the at least one groove 40 present in the plurality of members 11 and attached to the sixth member 11.

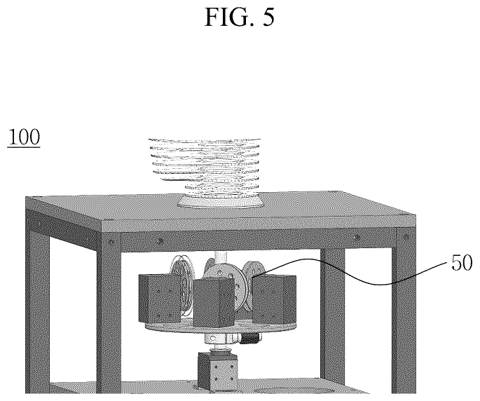

FIG. 5 is a diagram illustrating the working mechanism of the intelligent robot 100 according to an embodiment.

Referring to FIG. 5, the intelligent robot 100 according to an embodiment is connected to the motor 50 for applying a force to the power transmission element.

Here, the intelligent robot 100 according to an embodiment may be supplied with the power by the motor 50 connected to the other end of the power transmission element. In this instance, the motor 50 may be connected to the control unit (not shown) to communicate with the control unit to provide the intelligent robot 100 with the power of a corresponding magnitude to the audio input based on a signal received from the control unit.

The motor 50 may be installed below the intelligent robot 100 outside of the intelligent robot 100 to apply sufficient power to all the plurality of members 11 as shown in FIG. 5, but this is provided by way of illustration, and the motor 50 may be installed inside of the intelligent robot 100.

The power transmission element may be connected to the motor 50 in a straight line to minimize friction. In other words, the power transmission element may be supplied with the power from the motor 50 and connected tightly without bending so that the tension force is not applied to the plurality of members 11 or the flexible structure 12.

In the above-described particular embodiments, the elements included in the present disclosure are represented in singular or plural form according to the particular embodiments described herein. However, the singular or plural form is suitably selected for the given situations for convenience of description, and the above-described embodiments are not limited to the single or multiple elements, and a certain element represented in plural form may be a singular element, and a certain element represented in singular form may be multiple elements.

The method according to an embodiment of the present disclosure may be implemented into a computer program for performing a series of processes, and the computer program may be recorded in a computer readable recording medium. Examples of the computer readable recording medium may include hardware devices specially designed to store and execute program instructions, for example, magnetic media such as hard disk, floppy disk and magnetic tape, optical media such as CD-ROM and DVD, magneto-optical media such as floptical disk, and ROM, RAM and flash memory.

Although the present disclosure has been hereinabove described with reference to the embodiments, those skilled in the art will understand that a variety of modifications and changes may be made to the present disclosure without departing from the spirit and scope of the present disclosure set forth in the appended claims.

### DETAILED DESCRIPTION OF MAIN ELEMENTS

100: Intelligent robot
11: Member
12: Flexible structure
30: Lighting unit
40: Groove
50: Motor

What is claimed is:

1. An intelligent robot, comprising:
at least one processor; and
a memory configured to store instructions for executing the at least one processor,
wherein the intelligent robot includes:
a plurality of members stacked with gaps to form a shape of a face; and
at least one flexible structure disposed in at least one of the gaps, and
wherein when the instructions are executed by the at least one processor, the instructions cause at least one processor to control a motion of the face by applying a force to a power transmission element connected to at least one of the plurality of members based on an audio input.

2. The intelligent robot according to claim 1, wherein the plurality of members have a plate-shaped structure, at least some of the members are connected by the flexible structure, and the gaps are present between the plurality of members.

3. The intelligent robot according to claim 1, wherein the face is formed in a hollow 3-dimensional shape to form an accommodation space.

4. The intelligent robot according to claim 3, wherein when the instructions are executed by the at least one processor, the instructions cause the at least one processor to turn on or off light in an upward or downward direction by a light source on top or bottom of the intelligent robot inside of the intelligent robot.

5. The intelligent robot according to claim 1, wherein each of the plurality of members have at least one groove on an outer periphery thereof.

6. The intelligent robot according to claim 1, wherein the power transmission element is inserted into each of the at least one groove, the power transmission element having an end connected to at least one of the plurality of members and an opposite end connected to a motor installed inside or outside of the intelligent robot.

7. The intelligent robot according to claim 1, wherein the face of the intelligent robot is formed by stacking the plurality of members in a shape of a human's face including at least one of eyes, a nose or a mouth.

8. The intelligent robot according to claim 1, wherein when the instructions are executed by the at least one processor, the instructions cause the at least one processor to control the motion of the face by controlling a motor to apply a tension force to the power transmission element having an end connected to at least one of the plurality of members and an opposite end connected to the motor.

9. The intelligent robot according to claim 8, wherein when the instructions are executed by the at least one processor, the instructions cause the at least one processor to control the motion of the face by controlling at least one of torque or a number of revolutions of the motor to widen or narrow the gaps between the plurality of members.

10. The intelligent robot according to claim 1, wherein when the instructions are executed by the at least one processor, in case that a peak of the audio input is equal to or more than a preset size, the instructions cause the at least one processor to scale up the motion of the face corresponding to the peak.

11. The intelligent robot according to claim 1, wherein when the instructions are executed by the at least one processor, the instructions cause the at least one processor to control the face by a first motion for a first segment before a first syllable identified by splitting the audio input into syllables, and control the face by a second motion for a second segment after a last syllable of the audio input.

12. The intelligent robot according to claim 11, wherein the first motion is a first oral motion set based on a human's mouth shape formed to output the first syllable, and
wherein the second motion is a second oral motion set based on the human's mouth shape formed to silence after the last syllable.

13. The intelligent robot according to claim 4, wherein the light source is installed in the accommodation space, so that a light emitted from the light source leaks through the gaps between the plurality of members, causing the intelligent robot to glow.

14. The intelligent robot according to claim 4, wherein the light source is installed in the accommodation space and at least one of the plurality of members and flexible structure is produced by a semitransparent material, so that the light emitted from the light source is scattered from inside the intelligent robot to the outside, causing the intelligent robot to glow.

15. The intelligent robot according to claim 4, wherein the light source is installed in the accommodation space and at least one of the plurality of members and the flexible structure is produced by an opaque material, so that the light emitted from the light source is scattered in at least one of the plurality of members and flexible structure forming the intelligent robot.
